(19) United States
(12) Patent Application Publication
(10) Pub. No.: US 2005/0036160 A1
(43) Pub. Date: Feb. 17, 2005

(54) Image processing apparatus and method thereof

(75) Inventors: Fumitaka Goto, Kanagawa (JP); Mitsuhiro Ono, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/662,361

(22) Filed: Sep. 16, 2003

(30) Foreign Application Priority Data
Sep. 18, 2002 (JP) 2002-272184(PAT.)
Sep. 12, 2003 (JP) 2003-320669(PAT.)

(51) Int. Cl. G06K 1/00

(52) U.S. Cl. 358/1.9

(57) ABSTRACT

A direct printing apparatus has a small memory size since the apparatus cost must be suppressed, and the degree of freedom in an execution order of correction processes is low. In order to execute image correction after noise removal in such direct printing apparatus, the memory size must be increased to hold entire image data. Hence, upon applying, to image data, first correction according to the feature amounts of the entire image, and/or second correction which is different from the first correction, an effect processor (100) acquires the feature amounts of the entire image prior to execution of the first and second correction processes.

### FIELD OF THE INVENTION

The present invention relates to an image processing apparatus and method thereof and, more particularly, to a printing apparatus which prints an image by performing image processes on its own.

### BACKGROUND OF THE INVENTION

As printing apparatuses that print images, characters, and the like on print media such as paper sheets and the like, printers of various systems such as an ink-jet system, electrophotographic system, thermal transfer system, sublimatic system, and the like have been developed. These printing apparatuses print color images using three colors, i.e., cyan (C), magenta (M), and yellow (Y), or four colors, i.e., black (K) in addition to these three colors. Also, some apparatuses print color images using light colors such as light cyan (LC), light magenta (LM), light yellow (LY), and light black (LK).

Normally, image data is composed of additive primary colors (R, G, and B) data for light-emitting elements of a display and the like. However, since the colors of an image or the like printed on a print medium are expressed by reflection of light, color agents of subtractive primary colors (C, M, and Y) are used. Therefore, input R, G. and B data undergo a color conversion process into C, M, Y, and K (and also, LC, LM, LY, and LK) data.

A process for the purpose of improving image quality (effect process) is executed in addition to the color conversion process. For example, Japanese Patent Laid-Open No. 2000-13625 discloses a process for generating a histogram based on original image data, and correcting an image on the basis of a pixel value, the accumulated number of pixels of which has reached a predetermined value, and which is detected from a predetermined pixel value. Japanese Patent Laid-Open No. 2001-186365 discloses a process for calculating feature amounts of an input image, and correcting original image data on the basis of a processing condition according to the feature amounts. As another process, Japanese Patent Laid-Open No. 10-200751 discloses a technique for removing noise using a filter which outputs a weighted mean of the pixel value of interest and surrounding pixel values.

Image processes such as a color conversion process, effect process, and the like are normally executed by a computer such as a personal computer (PC). Recently, a printing apparatus which independently executes image processes without being connected to a host computer (direct printing apparatus), as disclosed in Japanese Patent No. 3161427, is available.

When the feature amounts of the overall image are acquired after the noise removal process, and image correction is to be made according to the image feature amounts, at least image data after noise removal must be stored in a memory. This is because the image correction is a process to be executed after the feature amounts of the overall image are extracted, and if noise removal is made before feature amounts are extracted, the noise removal process must be redone after feature amount extraction unless the entire image data after noise removal is stored in the memory, thus increasing the processing time.

On the other hand, when image data after noise removal is to be stored in a memory, a memory size that can hold the entire image data is required, and inevitably increases cost, as will be described later.

A host computer can easily hold entire image data after noise removal, and can extract feature amounts from image data before or after noise removal. In other words, the host computer has a high degree of freedom in an execution order of correction processes.

A direct printing apparatus has a smaller memory size than the host computer since the apparatus cost must be suppressed, and the degree of freedom in an execution order of correction processes is low. In such direct printing apparatus, if image feature amounts are to be acquired after noise removal process, the memory size must be increased to hold entire image data before or after noise removal.

In recent digital still cameras (DSCs), the number of recordable pixels increases greatly, and an image data size is increasing. Hence, if image correction is to be made after noise removal in the direct printing apparatus, a large-size memory must be equipped. Such memory considerably increases cost.

### SUMMARY OF THE INVENTION

The present invention has been made to solve the aforementioned problems individually or together, and has as its object to improve the degree of freedom in an execution order of a correction process according to image feature amounts and other correction processes without increasing inefficient processes and a memory size in an apparatus which performs image processes and prints an image.

In order to achieve the above object, a preferred embodiment of the present invention discloses an image processing apparatus comprising:
a corrector, arranged to apply, to image data, first correction according to a feature amount of an entire image, and second correction which is different from the first correction;
a processor, arranged to apply an image process required to print on a print medium to the image data output from the corrector; and
a recorder, arranged to print an image on the print medium on the basis of the image data that has undergone the image process,
wherein the corrector acquires the feature amount before execution of the first correction and before execution of the second correction is completed for the entire image data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic perspective view of an ink-jet printing apparatus;

FIG. 2 is a block diagram for explaining a control system for driving respective units of the printing apparatus;

FIG. 3 is a block diagram for explaining image processes in a controller;

FIG. 4 is a graph for explaining a color solid;

FIG. 5 is a flow chart for explaining acquisition of feature amounts of an analysis image;

FIG. 6 is a flow chart for explaining a process for determining image correction to be executed, and calculation of correction parameters;

FIG. 7 is a graph for explaining an expansion/contraction process in a luminance direction;

FIG. 8 is a graph for explaining color cast correction;

FIG. 9 is a graph for explaining an expansion/contraction process in a saturation direction;

FIG. 10 is a graph showing a tone correction curve;

FIGS. 11A to 11C are views for explaining noise removal by means of smoothing;

FIGS. 12A and 12B are views for explaining noise removal by means of high-frequency conversion of noise;

FIG. 13 is a view for explaining band data; and

FIGS. 14A and 14B are views for explaining a JPEG image data format.

### DETAILED DESCRIPTION OF THE PREFERRED EMBODIMENTS

Image processes according to an embodiment of the present invention will be described in detail hereinafter with reference to the accompanying drawings.

[Arrangement]

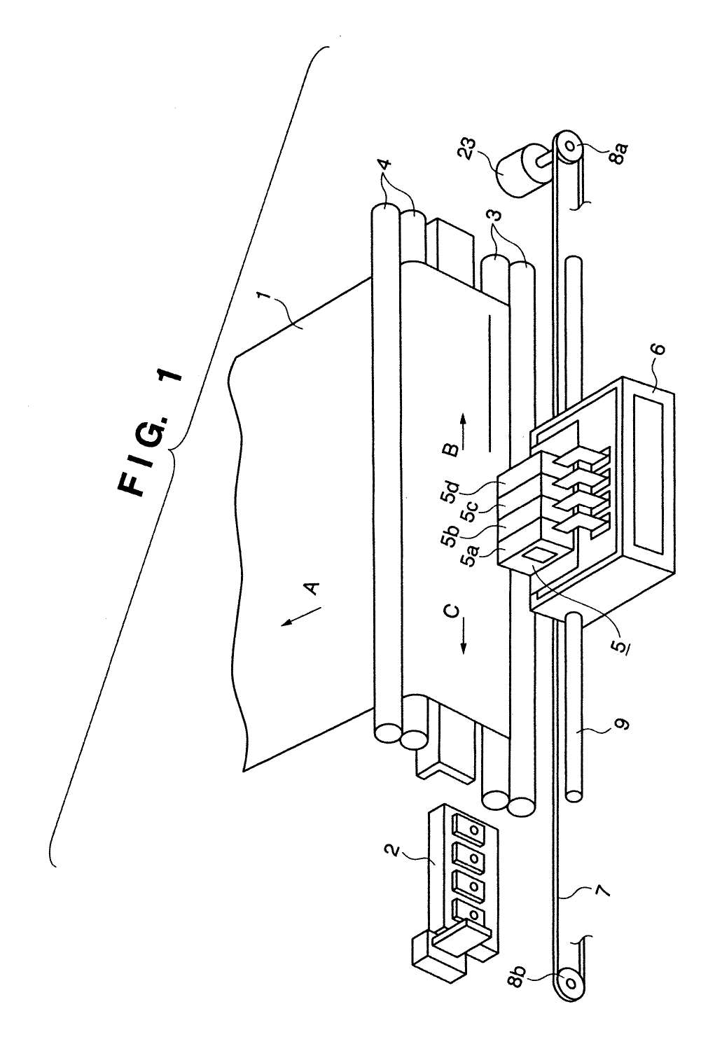

FIG. 1 is a schematic perspective view of an ink-jet printing apparatus.

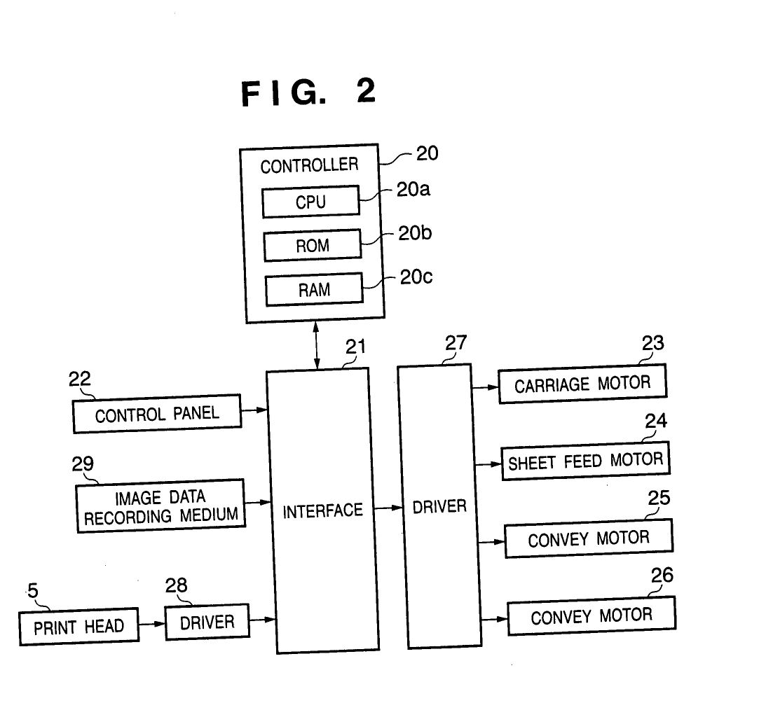

To the printing apparatus, print media 1 such as paper sheets, plastic sheets, or the like are fed one by one by a sheet feed roller (not shown) from a cassette (not shown) which can stack a plurality of print media 1. Convey roller pairs 3 and 4 are arranged to be separated by a predetermined spacing, and are respectively driven by drive motors 25 and 26 as shown in FIG. 2, so as to convey a print medium 1 fed by the sheet feed roller in the direction of arrow A shown in FIG. 1.

An ink-jet print head 5 used to print an image on a print medium 1 ejects inks supplied from ink cartridges (not shown) from nozzles in accordance with an image signal. The print head 5 and ink cartridges are mounted on a carriage 6 which is coupled to a carriage motor 23 via a belt 7 and pulleys 8a and 8b. The carriage 6 is driven by the carriage motor 23 to make reciprocal scans (two-way scans) along a guide shaft 9.

With this arrangement, inks are ejected onto a print medium 1 while moving the print head 5 in the direction of arrow B or C shown in FIG. 1, thus printing an image. The print head 5 is returned to a home position as needed to eliminate nozzle clogging by an ink recovery device 2, and the convey roller pairs 3 and 4 are driven to convey the print medium 1 for one line (a distance to be printed per scan) in the direction of arrow A. By repeating such operation, an image is printed on the print medium 1.

FIG. 2 is a block diagram for explaining a control system for driving respective units of a direct printing apparatus.

Referring to FIG. 2, a controller 20 comprises a CPU 20a such as a microprocessor or the like, a ROM 20b which stores a control program of the CPU 20a, an image processing program, various data, and the like, a RAM 20c which is used as a work area of the CPU 20a to temporarily save various data such as image data, mask data, and the like, and so forth.

The controller 20 is connected, via an interface 21, to a control panel 22, a driver 27 for driving various motors, a driver 28 for driving the print head 5, and an image data recording medium 29 which records image data.

The controller 20 receives various kinds of information (e.g., selection instructions of image quality and image processes, an image recording instruction, and the like) from the control panel 22, and exchanges image data with the image data recording medium 29 which holds image data. Note that the user can select image data recorded on the image data recording medium 29 such as a memory card (compact flash®, smart media®, memory stick®), and the like by operating the control panel 22.

The controller 20 outputs an ON/OFF signal to the driver 27 to drive the carriage motor 23 for driving the carriage, a sheet feed motor 24 for driving the sheet feed roller, and the convey motors 25 and 26 for driving the convey roller pairs 3 and 4. Furthermore, the controller 20 outputs image data corresponding to one scan of the print head 5 to the driver 28 to print an image.

The control panel 22 may be an external device connected with a printing apparatus. Further, the image data recording medium 29 may be an external device connected with the printing apparatus.

[Image Process]

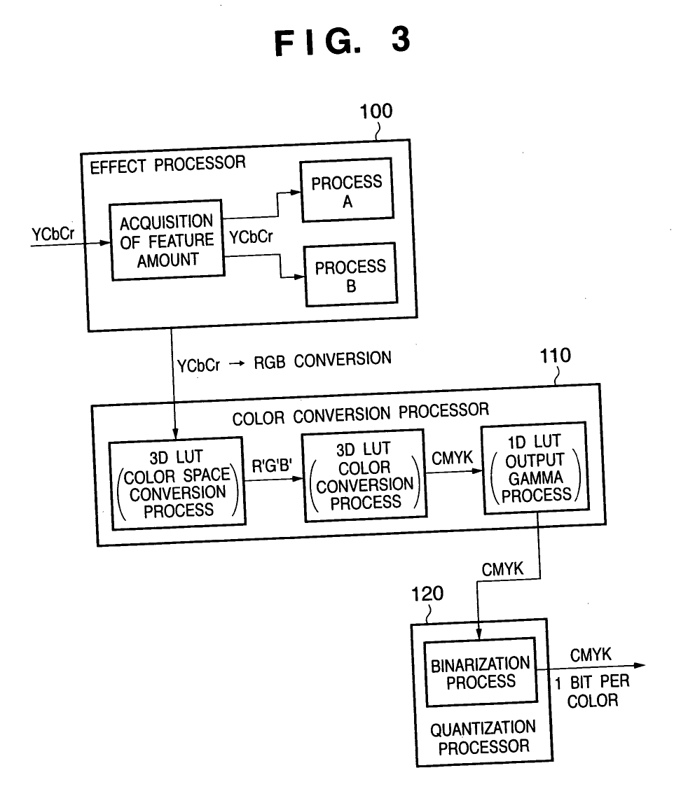

FIG. 3 is a block diagram for explaining image processes in the controller 20. The image processes in the controller 20 include an effect processor 100 which includes an acquisition process for acquiring image feature amounts (the amount of a characteristic of an image), process A for correcting an image based on correction parameters calculated based on the feature amounts, and process B which attains a process different from process A, a color conversion processor 110 which converts the color space of an input image into a color reproduction space of the printing apparatus, and a quantization processor 120 which quantizes image data.

After the feature amounts are calculated, which of processes A and B is to be executed first can be selected as needed. The effect processor 100, color conversion processor 110, and quantization processor 120 will be explained in turn below.

Effect Processor

In order to perform process A in the effect processor 100, feature amounts of an original image are acquired before correction of process A. The original image is an image before process A, and includes a partial region such as a trimming image which does not undergo process A. The feature amounts can be acquired based on either all data or a representative value group of the original image. Note that representative values include pixel values which are regularly or randomly selected from the original image, those of a reduced-scale image of the original image, or DC component values of a plurality of pixels of the original image. A set of data used to acquire image feature amounts will be referred to as an “analysis image” hereinafter. The analysis image can be image data itself which is to undergo process A, or a representative value group. If the process A to be applied to a processed or corrected image, the analysis image can be image data itself that is a processed or corrected image, or the representative value group of the processed or corrected image. In this embodiment, the feature amounts are acquired using a luminance component (Y) and color difference components (Cb, Cr).

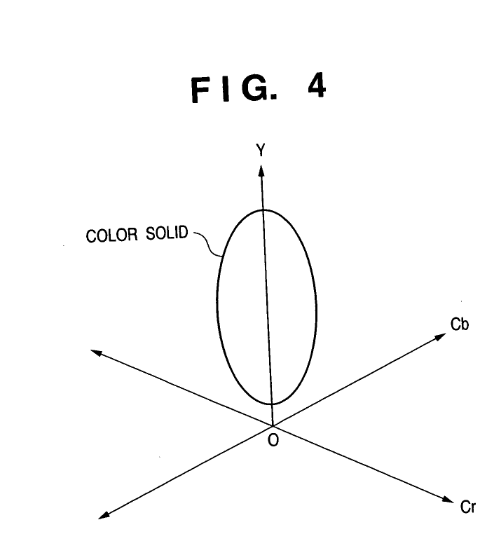

Upon plotting an analysis image on a three-dimensional (3D) space defined by Y, Cb, and Cr, a color solid is formed, as shown in FIG. 4. The feature amounts are information representing the features of the color solid of the analysis image. For example, the feature amounts include histograms, information associated with the luminance and color difference values, and hue and saturation values of highlight and shadow points, and the like (to be described later). However, the present invention is not limited to such specific examples, and all features based on the analysis image are included in the feature amounts of this embodiment.

As will be described later, since there are a plurality of correction processes corresponding to process A, whether or not these processes are to be executed is independently determined, and correction parameters of the correction process or processes which is or are determined to be executed are calculated. Correction parameters of the correction process or processes which is or are determined not to be executed may be set to values (e.g., 1 and 0) that actually disable correction. The correction parameters are data used to deform the color solid, and are expressed by, e.g., values, a matrix, table, filter, or graph. However, the present invention is not limited to such specific examples. After the correction parameters are calculated, the correction process or processes is or are executed. If no correction process to be executed is selected, a process that does not correct the color solid (normal process) is executed.

[Process A]

Process A may be those described in Japanese Patent Laid-Open Nos. 2000-13625 and 2001-186365, and need only correct using the correction parameters calculated according to the feature amounts of the original image.

Acquisition of Feature Amounts of Analysis image

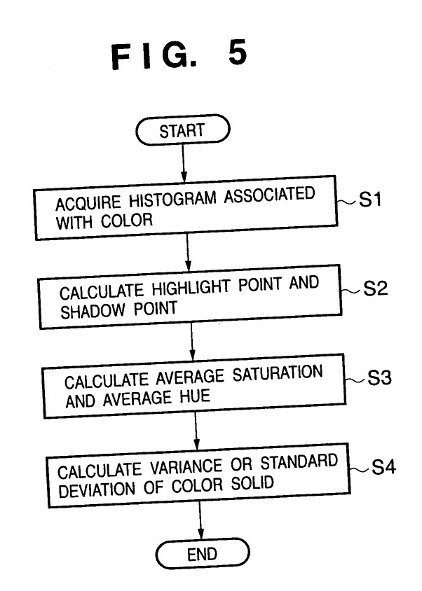

FIG. 5 is a flow chart for explaining acquisition of the feature amounts of the analysis image.

One or more histograms associated with colors of the analysis image is acquired (S1). Upon plotting the analysis image on the 3D space defined by Y, Cb, and Cr, the color solid shown in FIG. 4 is formed. Upon acquisition of the histogram associated with colors, at least one of a plurality of pieces of following information associated with the color solid is acquired.
1. luminance histogram
2. color difference histogram
3. color difference histogram for each luminance level
4. saturation histogram
5. saturation histogram for each luminance level
6. hue histogram
7. hue histogram for each luminance level

Then, a highlight point (a luminance level that represents a highlight part) and a shadow point (a luminance level that represents a shadow part) are calculated (S2). More specifically, in the acquired luminance histogram, pixels are counted from the highlight side, and a luminance value whose count value has reached a threshold value obtained by multiplying the total number of pixels by a predetermined ratio is selected as highlight point HL_{Y}. Also, pixels are counted from the shadow side, and a luminance value whose count value has reached a threshold value obtained by multiplying the total number of pixels by a predetermined ratio is selected as shadow point SD_{Y}. Note that each of highlight point HL_{Y} and shadow point SD_{Y} may assume a luminance value around the luminance value at which the count value (cumulative frequency) has reached the threshold value.

The average values of color differences Cb and Cr at highlight point HL_{Y} are calculated from the color difference histogram at highlight point HL_{Y}, and are set as color differences Cb_{HL} and Cr_{HL} at the highlight point. Likewise, the average values of color differences Cb and Cr at shadow point SD_{Y} are calculated from the color difference histogram at shadow point SD_{Y}, and are set as color differences Cb_{SD} and Cr_{SD} at the shadow point.

At least one of the average saturation and average hue is calculated (S3), and a variance or standard deviation of at least one of luminance levels, color difference levels, saturation levels, and hue levels, which form the color solid, is calculated (S4).

The histograms and numerical values obtained in steps S1 to S4 are the image feature amounts.

Determination of Image Correction to be Executed

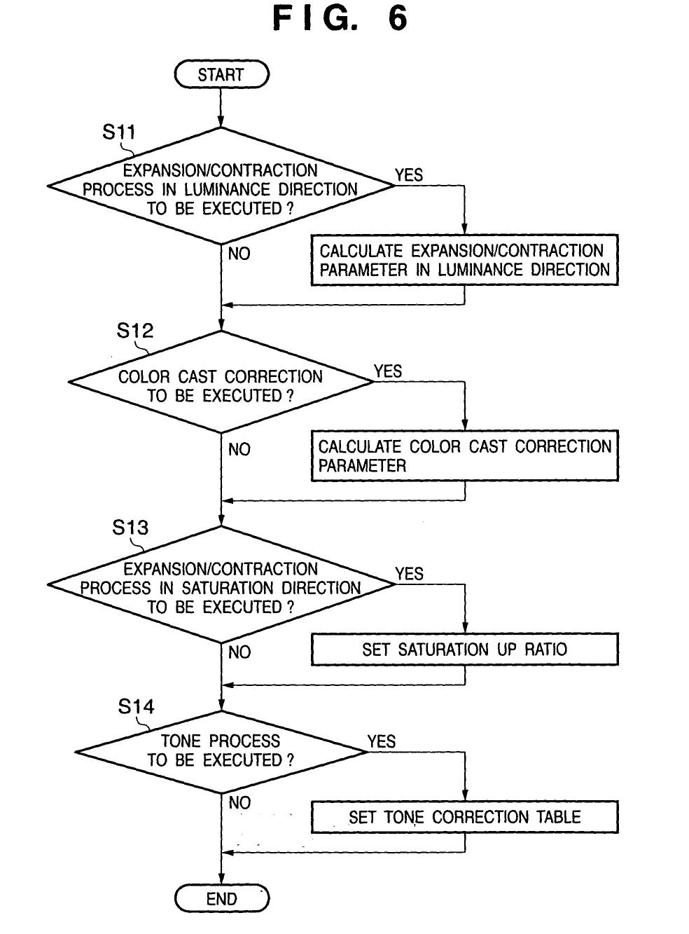

FIG. 6 is a flow chart for explaining a process for determining image correction to be executed, and calculation of correction parameters.

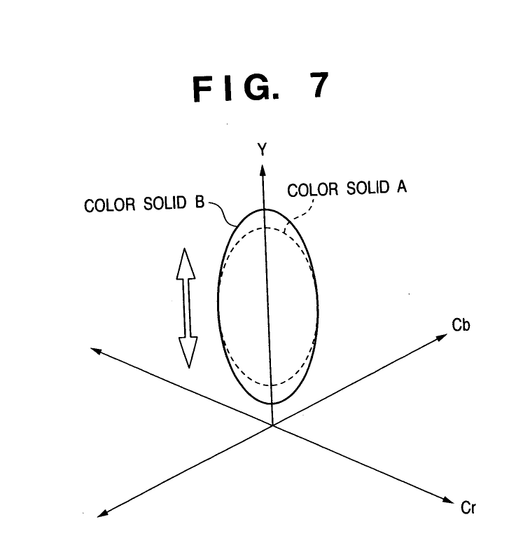

It is determined whether or not an expansion/contraction process in the luminance direction is to be executed (S11). The expansion process in the luminance direction expands color solid A in the luminance direction like color solid B, and the contraction process in the luminance direction contracts color solid B in the luminance direction like color solid A, as shown in FIG. 7.

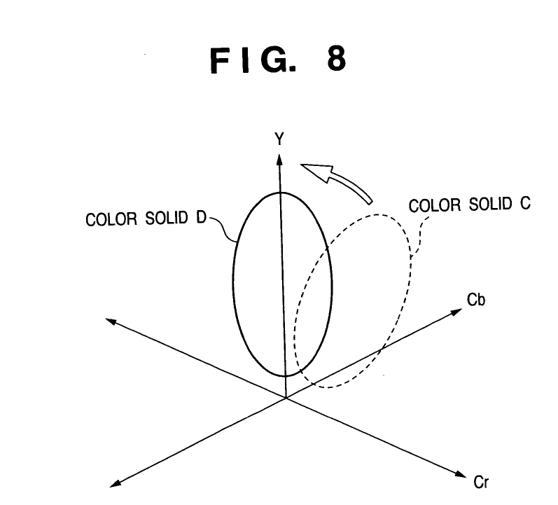

It is determined whether or not a color cast correction process is to be executed (S12). The color cast correction process rotates color solid C, which has a slope with respect to the luminance axis, to obtain color solid D that extends along the luminance axis, as shown in FIG. 8.

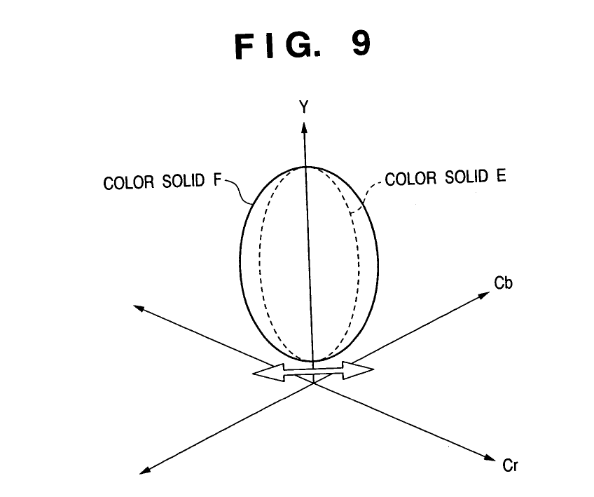

It is determined whether or not an expansion/contraction process in the saturation direction is to be executed (S13). The expansion process in the saturation direction expands color solid E in the saturation direction like color solid F, and the contraction process in the saturation direction contracts color solid F in the saturation direction like color solid E, as shown in FIG. 9.

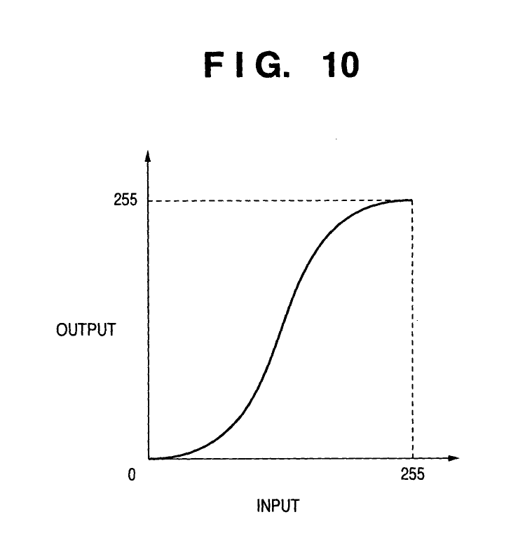

It is determined whether or not a tone process is to be executed (S14). The tone process converts luminance values using a tone correction curve shown in, e.g., FIG. 10.

These determination steps are attained based on the feature amounts calculated in the process shown in FIG. 5. For example, whether or not the expansion/contraction process in the luminance direction is to be executed is determined by comparing the total frequency (total number of pixels) of the luminance histogram with a threshold value, comparing the count value at the highlight or shadow point with a threshold value, and comparing the luminance difference (HL_{Y}−SD_{Y}) between the highlight and shadow points with a threshold value.

Also, whether or not the expansion/contraction process in the luminance direction is to be executed is determined by the highlight and shadow points with a threshold value and comparing the variance value with a threshold value. Whether or not the color cast correction process is to be executed is determined by comparing the slope of an axis that connects the highlight and shadow points or the distance between the axis that connects the highlight and shadow points, and the luminance axis (e.g., the distance between the highlight point and a maximum point on the luminance axis, the distance between the shadow point and a minimum point on the luminance axis, the distance between middle points of the respective axes, or the like) with a threshold value. Whether or not the expansion/contraction process in the saturation direction is to be executed is determined by comparing the average saturation with a threshold value.

Calculation of Correction Parameter

If it is determined that the expansion/contraction process in the luminance direction is to be executed, expansion/contraction parameters in the luminance direction are calculated (S21). More specifically, a highlight point (Dst_{HL}) and shadow point (Dst_{SD}) as destinations of movement of a highlight point (Src_{HL}) and shadow point (Src_{SD}) of an original image are set. Note that the points as the destinations of movement may assume fixed values, Dst_{HL} may be set at a luminance level higher than Src_{HL}, and Dst_{SD} may be set at a luminance level lower than Src_{SD}.

If it is determined that the color cast correction is to be executed, a 3×3 matrix used to move a unit vector of a vector (Src_{HL}−Src_{SD}) to that of a vector (Dst_{HL}−Dst_{SD}) is calculated, and the translation amount of the color solid is calculated (S22).

If it is determined that the expansion/contraction process in the saturation direction is to be executed, a saturation up ratio is set (S23). The saturation up ratio may be either a fixed value or variable according to the average saturation.

If it is determined that the tone process is to be executed, a tone correction curve is set (S24). The tone correction curve is set using the highlight and shadow points, and histogram distribution.

[Process B]

Process B is different from process A, and noise correction will be exemplified below.

As noise correction, a method of obscuring noise by smoothing pixel values, and a method of obscuring noise by converting low-frequency noise to high-frequency noise are available. The former correction method uses a filter.

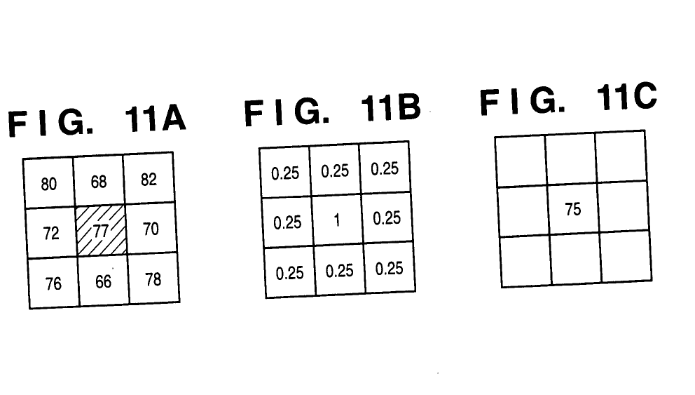

FIGS. 11A to 11C are views for explaining the method of obscuring noise by smoothing. The central pixel in a block formed by 3×3 pixels (a total of nine pixels) shown in FIG. 11A is a pixel of interest, which is to be corrected. The 3×3 pixels undergo a filter process of 3×3 pixels shown in FIG. 11B. Needless to say, the pixels in FIG. 11A correspond to those of the filter shown in FIG. 11B, and values in the filter are weighting coefficients. That is, color data of the respective pixels shown in FIG. 11A are multiplied by the corresponding weighting coefficients of the filter (FIG. 11B), and the nine products for each color are summed up. Then, the sum is divided by the sum of the weighting coefficients to obtain a value of the pixel of interest for each color after smoothing (FIG. 11C). Of course, all weighting coefficients may be set to “1” (not to weight), and the average value of 3×3 pixels may be set as the value of the pixel of interest.

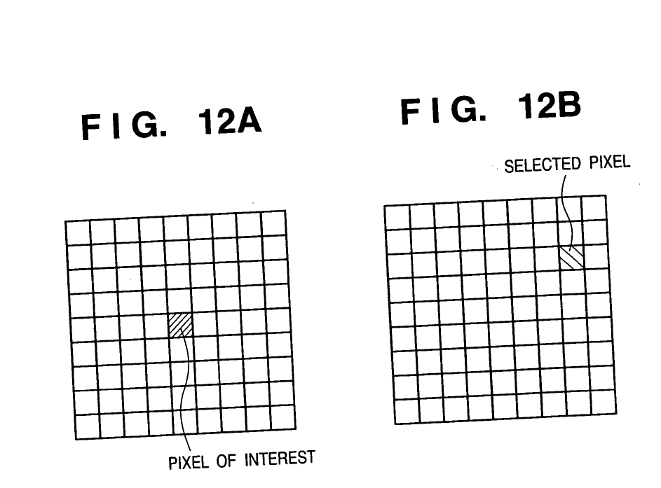

FIGS. 12A and 12B are views for explaining a method of obscuring noise by converting low-frequency noise into high-frequency noise. The central pixel in a block formed by 9×9 pixels (a total of 81 pixels) shown in FIG. 12A is a pixel of interest, which is to be corrected. A pixel randomly selected from those 9×9 pixels is set as a selected pixel (FIG. 12B). Pixel values for respective colors of the pixel of interest and the selected pixel are compared with each other, and if their differences of all colors fall within threshold value ranges, the values of the pixel of interest are substituted by those of the selected pixel.

Note that noise correction described using FIGS. 12A and 12B is performed in this embodiment. Noise correction is made using Y, Cb, and Cr values. Of course, the functions and effects of this embodiment will never impair if the noise correction based on smoothing and R, G, and B values are used in place of Y, Cb, and Cr. Also, the block size is not limited to those shown in FIGS. 11A to 11C and FIGS. 12A and 12B.

[Color Conversion Processor]

The printing apparatus of this embodiment has C, M, Y, and K inks, and a color conversion process suitable for such printing apparatus will be explained below.

In processes A and B, Y, Cb, and Cr data are used. The Y, Cb, and Cr data that have undergone processes A and B are converted into R, G, and B data as the input color space of a pre-color conversion process (to be described later) by:
R=Y+1.402(Cr−128)
G=Y−0.34414(Cb−128)−0.71414(Cr−128)
B=Y+1.772(Cb−128)

The obtained R, G, and B data are converted into R′, G′, and B′ data by a 3D lookup table (3DLUT) shown in FIG. 3. This process is called a color space conversion process (pre-color conversion process), and corrects the difference between the color space of an input image and the color reproduction space of the printing apparatus.

The R′, G′, and B′ data that have undergone the color space conversion process are converted into C, M, Y, and K data using the next 3DLUT. This process is called a color conversion process (post-color process), and converts the RGB-based colors of the input system into CMYK-based colors of the output system.

The 3DLUTs used in the pre-color process and post-color process discretely hold data. Hence, data which are not held in these 3DLUTs are calculated from the held data by a known interpolation process.

The C, M, Y, and K data obtained by the post-color process undergo output gamma correction using a one-dimensional LUT. The relationship between the number of dots to be printed per unit area and the output characteristics (reflection density and the like) are not linear in most cases. Hence, the output gamma correction guarantees a linear relationship between C, M, and Y data and their output characteristics.

The operation of the color conversion processor 110 has been explained, and R, G, and B data are converted into C, M, Y, and K data of color agents of the printing apparatus.

[Quantization Processor]

Since the printing apparatus of this embodiment is a binary printing apparatus, it finally quantizes (binarizes) C, M, Y, and K multi-valued data to C, M, Y, and K 1-bit data.

In this embodiment, quantization is implemented by known error diffusion which can smoothly express halftone of a photo image in a binary print process. C, M, Y, and K 8-bit data are quantized to C, M, Y, and K 1-bit data by error diffusion.

[First Embodiment]

As the first embodiment, a case will be exemplified below wherein calculation of the image feature amounts, execution of process B, and that of process A are made in the direct printing apparatus.

The user selects an image to be printed on a print medium 1 using the control panel 22, and issues a print start instruction. Image data of the selected image is copied from the image data recording medium 29 to the RAM 20c, and the image processing program is called from the ROM 20b. The CPU 20a which executes the image processing program renders image data stored in the RAM 20c to generate a reduced-scale image using Y, Cb, and Cr data as an analysis image. In this case, a known reduction method such as nearest neighbor, bilinear, bicubic, and the like is used. Note that the image data rendering process includes a process for expanding JPEG-compressed image data to obtain bitmap data and so forth.

The analysis image is passed to the effect processor 100 implemented by the image processing program, and histograms associated with Y, Cb, and Cr are acquired (S1) in accordance with the flow chart shown in FIG. 5. Assume that the luminance histogram, color difference histogram for each luminance level, saturation histogram, and hue histogram are acquired. After the analysis image is analyzed to acquire these histograms, a memory area which holds the analysis image is released, and the released memory area is used as a band memory that holds band data to be described later, thus efficiently utilizing the memory.

As the calculation of the feature amounts, highlight and shadow points, and average color differences at the highlight and shadow points are calculated from the luminance histogram and the color difference histograms for each luminance level (S2). More specifically, (i) feature amounts, i.e., highlight and shadow points, are calculated from the luminance histogram, and (ii) color difference histograms corresponding to the calculated highlight and shadow points are obtained from color difference histograms for each luminance level, and feature amounts, i.e., the average color differences of these points, are calculated. Subsequently, the average saturation is calculated from the saturation histogram (S3), and the variance of hue values is calculated from the hue histogram (S4).

Correction processes to be executed are determined, and correction parameters are calculated according to the flow chart shown in FIG. 6. As correction parameters, a 3×3 matrix, one or more saturation correction parameters, and tone correction table, which are used to move/deform a color solid, are calculated. Note that the 3×3 matrix is calculated with the inclusion of expansion/contraction parameters in the luminance direction.

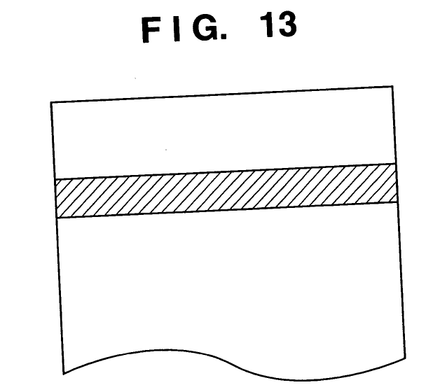

Partial data (corresponding to the memory size of the RAM 20C) of original image data is passed to the effect processor 100. For example, hatched partial data (band data) of the original image data is passed to the effect processor 100, as shown in FIG. 13. The effect processor 100 executes the following noise correction as process B for the received band data. That is, the processor 100 compares the differences between the values of respective colors of the pixel of interest and those of the selected pixel shown in FIGS. 12A and 12B with the threshold values, and replaces the values of the pixel of interest by those of the selected pixel if the differences for all colors fall within the threshold value ranges.

The effect processor 100 then executes process A for the band data that has undergone the noise correction using the already calculated correction parameters. The band data which has undergone processes B and A is sent to the print head 5 via the color conversion processor 110 and quantization processor 120, and an image for one band is printed on the print medium 1. After that, the original image data undergoes image processes for respective bands, thus printing an entire image when the whole original image data is processed.

In this embodiment, the band data is held in the band memory. For example, the band memory has a size of 5400×9×3 bytes. “5400” corresponds to the horizontal size, “9”, the vertical size, and “3”, the number of colors. That is, if the input resolution of the printing apparatus is 600 dpi, and the output horizontal size is 9″, a horizontal size of 600×9=5400 pixels is required. When the selected pixel is randomly selected form 9×9 pixels in process B above, a vertical size of 9 pixels is required. When the correction process is executed for three colors Y, Cb, and Cr, the number of colors=3 is required. Of course, the band memory size is not limited to such particular size, and may be appropriately set in correspondence with the input resolution, the output size, the number of colors to be processed, the memory size, and the like. When a sufficient band memory cannot be assured, i.e., when a horizontal size of 5400 pixels cannot be assured in the above example, a block memory having a size obtained by further dividing the band memory in the horizontal direction may be assured to execute processes A and B for respective blocks.

In this way, since the feature amounts of an image are acquired first, both processes B and A can be executed for respective bands or blocks, and the memory size of the direct printing apparatus need not be increased to hold the entire image data before or after process B. As described in the summary of the invention, process B need not be executed an extra number of times, and an increase in processing time can be suppressed.

Of course, the feature amounts can be acquired after partial data of image data undergoes process B. For example, the analysis image is held in an analysis image memory in addition to the band memory, and process B is applied to data corresponding to the first one of bands to be processed. Then, the feature amounts are acquired from the analysis image by the aforementioned means to calculate correction parameters for process A. After that, process A is applied to the data corresponding to the first band that has undergone process B. However, in this example, since the analysis image memory must be held in addition to the band memory before the analysis image is analyzed, it is preferable to analyze an image first, and to release the analysis image memory in terms of effective use of the memory. Also, a code of an exception process to acquire the feature amounts of the first band alone is required.

As another example, only histograms of the feature amounts are acquired from the analysis image, and the analysis image memory is released. After process B is applied to band data, feature amounts such as the highlight point and the like are acquired from the histograms. In this way, the feature amount acquisition timings may be shifted.

In addition to the above example, after process B is applied to some data of the first band, the feature amounts may be acquired from the analysis image. Also, after only process B is applied to a plurality of bands, the feature amounts may be acquired from the analysis image. Furthermore, in a borderless print mode, when data corresponding to a non-print region or a region which is not conspicuous upon printing is to be processed, no feature amounts are acquired; only when data corresponding to a region to which process A is to be applied is to be processed, the feature amounts may be acquired. In this case, process A can be applied to only bands after the feature amounts are acquired.

The gist of the present invention lies in the acquisition timing of the feature amounts of the overall image. The feature amount acquisition timing is set before execution of process A based on the feature amounts, and before process B, which is different from process A, is applied to the entire image (before completion of process B to be applied to the entire image). Therefore, the aforementioned examples are included in the gist of the present invention. When process A is executed based on the feature amounts of the image that has undergone process B, process B is applied to the entire image for respective bands, the feature amounts are acquired from the image that has undergone process B, and processes B and A are executed unless a memory for holding the entire image is assured. Hence, such case is also included in the acquisition timing of the gist of the present invention. The feature amount acquisition timing of the present invention is effective for respective images even when one or more images are to be printed using a plurality of layouts or on a plurality of sheets.

In the above example, process A is executed after process B. However, after the feature amounts are acquired, and correction parameters are calculated, process A may be executed first. Also, a reduced-scale image is generated as the analysis image. However, an original image itself may be used as the analysis image. In such case, pixels may be appropriately selected from the original image, and the histograms may be acquired from the selected pixels.

Furthermore, each of process A based on the feature amounts and another process B need not be one process. The present invention can be applied if a plurality of processes are to be executed as processes A and B.

The direct printing apparatus has been exemplified. Even in image processes on a host computer, when the feature amounts of an image are acquired first, the entire image data before or after process B need not be held in the memory, thus allowing efficient use of the memory.

[Second Embodiment]

In the first embodiment, feature amounts are acquired in advance using the reduced-scale image as the analysis image. The second embodiment will exemplify a case wherein feature amounts are acquired upon decoding a JPEG-encoded image (JPEG image).

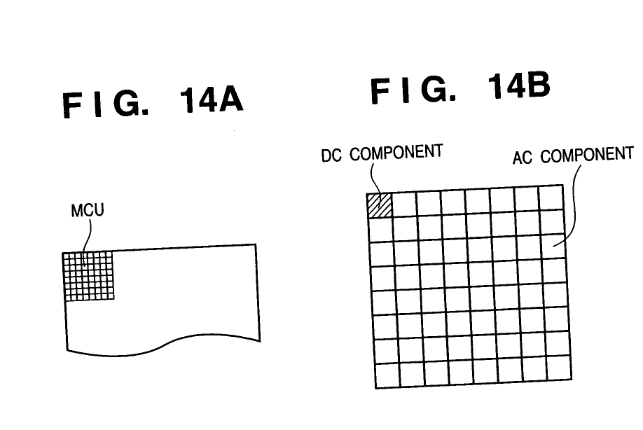

In general, JPEG segments an image into blocks (Minimum Coded Units: MCUs) each of which consists of 8×8 pixels, as shown in FIG. 14A, and computes the discrete cosine transforms (DCT) of respective pixels in each MCU to obtain DC and AC components of each MCU, as shown in FIG. 14B. The DC component undergoes DPCM (Differential Pulse Code Modulation) and then Huffman-encoding. The AC components are quantized and then entropy-encoded.

Upon execution of dequantization upon decoding a JPEG image, DC and AC components in each MCU can be acquired, as shown in FIG. 14B. When the DC component is acquired from each MCU to acquire Y, Cb, and Cr of the DC component, histograms associated with the colors of an image can be acquired.

Therefore, the histograms associated with colors are acquired in advance from the DC component, and feature amounts such as a highlight point and the like are calculated from the acquired histograms. Then, correction parameters are calculated, and processes A and B can be executed. In this embodiment as well, since the feature amounts of an image are acquired in advance, the entire image data before or after process B need not be held in the memory, and efficient use of the memory is realized. Also, extra processes described in the summary of the invention and the first embodiment need not be executed.

[Third Embodiment]

The third embodiment will exemplify a case wherein feature amounts are acquired from image information appended to image data. The appended image information contains feature amounts such as histograms associated with colors (e.g., a luminance histogram), highlight and shadow points, and the average values and variance values of values associated with colors, a thumbnail image, and the like. By acquiring these feature amounts from the image information appended to image data, correction parameters are calculated, and processes A and B can be executed. If the appended image information already contains desired feature amounts, these feature amounts may be directly used, and if a thumbnail image is used, the thumbnail image may be processed as the analysis image described in the first embodiment.

Therefore, in this embodiment as well, since the feature amounts of an image are acquired in advance, the entire image data before or after process B need not be held in the memory, and efficient use of the memory is realized. Also, extra processes described in the summary of the invention and the first and second embodiments need not be executed.

Note that the present invention may be applied to either a system constituted by a plurality of devices (e.g., a host computer, an interface device, a reader, a printer, and the like), or an apparatus consisting of a single equipment (e.g., a copying machine, a facsimile apparatus, or the like).

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a floppy disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

The present invention includes a product, e.g., a printout, obtained by the image processing method of the present invention.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to the flowcharts described in the embodiments.

As many apparently widely different embodiments of the present invention can be made without departing from the spirit and scope thereof, it is to be understood that the invention is not limited to the specific embodiments thereof except as defined in the claims.

1. An image processing apparatus comprising:
a corrector, arranged to apply, to image data, first correction according to a feature amount of an entire image, and second correction which is different from the first correction;
a processor, arranged to apply an image process required to print on a print medium to the image data output from said corrector; and
a recorder, arranged to print an image on the print medium on the basis of the image data that has undergone the image process,
wherein said corrector acquires the feature amount before execution of the first correction and before execution of the second correction is completed for the entire image data.

2. The apparatus according to claim 1, wherein said corrector acquires the feature amount from the entire image data or partial data.

3. The apparatus according to claim 1, wherein said corrector acquires the feature amount from the entire image data or a representative value group of partial data.

4. The apparatus according to claim 3, wherein the representative value group includes at least one of pixel values regularly selected from the image data, pixel values randomly selected from the image data, pixel values of reduced-scale image data of the image data, and DC component values of a plurality of pixels of the image data.

5. The apparatus according to claim 1, wherein said corrector acquires the feature amount from data appended to the image data.

6. The apparatus according to claim 5, wherein the data appended to the image data includes at least one of the feature amount and thumbnail image of the image data.

7. The apparatus according to claim 1, wherein the feature amount includes at least one of histograms associated with some colors, information associated with some colors that represents a highlight part, information associated with some colors that represents a shadow part, and information associated with hue and saturation in the entire image data or partial data.

8. An image processing method comprising the steps of:
applying, to image data, first correction according to a feature amount of an entire image, and second correction which is different from the first correction;
applying an image process required to print on a print medium to the corrected image data;
printing an image on the print medium on the basis of the image data that has undergone the image process; and
acquiring the feature amount before execution of the first correction and before execution of the second correction is completed for the entire image data.

9. A computer program for an image processing method, the method comprising the steps of:
applying, to image data, first correction according to a feature amount of an entire image, and second correction which is different from the first correction;
applying an image process required to print on a print medium to the corrected image data;
printing an image on the print medium on the basis of the image data that has undergone the image process; and
acquiring the feature amount before execution of the first correction and before execution of the second correction is completed for the entire image data.

10. A computer program product storing a computer readable medium comprising a computer program code, for an image processing method, the method comprising the steps of:
applying, to image data, first correction according to a feature amount of an entire image, and second correction which is different from the first correction;
applying an image process required to print on a print medium to the corrected image data;
printing an image on the print medium on the basis of the image data that has undergone the image process; and
acquiring the feature amount before execution of the first correction and before execution of the second correction is completed for the entire image data.

11. A printer comprising:
an interface, arranged to input image data from a memory card; and
a processor, arranged to perform a first process for performing correction, which is based on the amount of characteristic of an image expressed by the input image data, on the image data, and a second process for performing predetermined processing on the image data,
wherein the amount of the characteristic is extracted before the first and second processes are performed.
